(19) United States
(12) Patent Application Publication
(10) Pub. No.: US 2015/0303519 A1
(43) Pub. Date: Oct. 22, 2015

(54) NONAQUEOUS ELECTROLYTE SECONDARY BATTERY AND PRODUCTION METHOD THEREOF

(71) Applicant: TOYOTA JIDOSHA KABUSHIKI KAISHA, Toyota-shi (JP)

(72) Inventor: Ryo HANAZAKI, Toyota-shi (JP)

(73) Assignee: TOYOTA JIDOSHA KABUSHIKI KAISHA, Toyota-shi (JP)

(21) Appl. No.: 14/682,526

(22) Filed: Apr. 9, 2015

(30) Foreign Application Priority Data
Apr. 18, 2014 (JP) 2014-086666

(51) Int. Cl. H01M 10/0567

(52) U.S. Cl. CPC H01M 10/0567

(57) ABSTRACT

Provided is a nonaqueous electrolyte secondary battery having both superior output characteristics and durability. The positive electrode and the negative electrode of this battery are respectively provided with a film containing lithium ions and fluoride ions. The film of the positive electrode is such that a ratio (C1/C2) of a first peak intensity C1 of 58 to 62 eV to a second peak intensity C2 of 68 to 72 eV, based on X-ray absorption fine structure (XAFS) analysis of the Li—K absorption edge, is 2.0 or more, and the fluoride ions are contained at 1.99 μg/mg to 3.13 μg/mg per unit mass of the positive electrode active material layer. In addition, the film of the negative electrode is such that a ratio (A1/A2) of a first peak intensity A1 of 58 to 62 eV to a second peak intensity A2 of 68 to 72 eV, based on X-ray absorption fine structure (XAFS) analysis of the Li—K absorption edge, is 2.0 or less.

### TECHNICAL FIELD

The present invention relates to a nonaqueous electrolyte secondary battery and a production method thereof.

The present application claims priority on the basis of Japanese Patent Application No. 2014-086666 filed on Apr. 18, 2014, the contents of which are incorporated herein by reference.

### BACKGROUND ART

Studies are being conducted to increase the output density of lithium ion secondary batteries and other nonaqueous electrolyte secondary batteries in an attempt to improve their performance. For example, Patent Literature 1 describes a technology for forming a film containing a reaction product of a fluorine-containing lithium salt and water (and typically, lithium ions and fluoride ions) on the surface of a negative electrode having a moisture concentration (heating temperature: 120° C.) of 100 to 400 ppm when constructing a battery by using that negative electrode. According to Patent Literature 1, increases in internal resistance can be inhibited by this film.

### CITATION LIST

### Patent Literature

[Patent Literature 1] Japanese Patent Application Laid-open No. 2008-108463

[Patent Literature 2] Japanese Patent Application Laid-open No. 2008-108462

[Patent Literature 3] WO 2013/069064

[Patent Literature 4] Japanese Patent Application Laid-open No. 2008-282613

[Patent Literature 5] Japanese Patent Application Laid-open No. 2014-010981

### SUMMARY OF INVENTION

However, the above-mentioned technology does not define the moisture concentration of a positive electrode. According to a study conducted by the inventor of the present invention, if the moisture concentration of the positive electrode is excessively high, for example, an excess of film is formed on the surface of the positive electrode and output characteristics may decrease. On the other hand, if the moisture concentration of the positive electrode is excessively low, Li release of the positive electrode becomes excessively large and the acceptance of lithium ions by a negative electrode may be unable to keep up. In such cases, lithium metal precipitates on the surface of the negative electrode and battery input characteristics and durability (such as resistance to Li precipitation or cycling characteristics) may decrease. Moreover, during the course of further studies conducted by the present inventor, not only the “amount” of film formed on the surface of the electrodes, but also the “properties (quality)” thereof, were newly determined to be important.

With the foregoing in view, an object of the present invention is to provide a nonaqueous electrolyte secondary battery having both superior output characteristics and high durability. Another related object is to provide a method for stably producing that battery.

The inventor of the present invention considered adjusting the release of a charge carrier at the positive electrode and the acceptance of a charge carrier at the negative electrode to a preferable balance by optimizing the amount and properties of films formed on the positive electrode and the negative electrode. The inventor of the present invention then conducted extensive studies that led to completion of the present invention.

According to the present invention, a nonaqueous electrolyte secondary battery is provided that is provided with a positive electrode provided with a positive electrode active material layer, a negative electrode provided with a negative electrode active material layer and a nonaqueous electrolyte containing a lithium salt having fluorine as a constituent thereof (F-containing lithium salt). The positive electrode and the negative electrode are respectively provided with a film containing lithium ions and fluoride ions. The film of the positive electrode is such that the ratio (C1/C2) of a first peak intensity C1 of 58 to 62 eV to a second peak intensity C2 of 68 to 72 eV, based on X-ray absorption fine structure (XAFS) analysis of the Li—K absorption edge, is 2.0 or more, and the fluoride ions are contained at 1.99 μg/mg to 3.13 μg/mg per unit mass of the positive electrode active material layer. In addition, the film of the negative electrode is such that the ratio (A1/A2) of a first peak intensity A1 of 58 to 62 eV to a second peak intensity A2 of 68 to 72 eV, based on X-ray absorption fine structure (XAFS) analysis of the Li—K absorption edge, is 2.0 or less.

By making the amount of fluoride ions per unit mass of the positive electrode active material layer to be 3.13 μg/mg or less, resistance during discharge can be suppressed to a low level and high output characteristics can be realized. In addition, by making the amount of fluoride ions per unit mass of the positive electrode active material layer to be 1.99 μg/mg or more and making the XAFS peak intensity ratio C1/C2 of the positive electrode to be 2.0 or more (such as from 2.2 to 2.4), the positive electrode can be given suitable resistance and release of the charge carrier (Li) at the positive electrode can be suitably inhibited. Moreover, by making the XAFS peak intensity ratio A1/A2 of the negative electrode to be 2.0 or less (such as from 1.2 to 1.3), resistance of the negative electrode can be reduced and acceptance of the charge carrier (Li) at the negative electrode can be secured.

In the configuration of the present invention, high input characteristics and durability (Li precipitation resistance) can be realized due to these synergistic effects. Thus, a nonaqueous electrolyte secondary battery having both superior output characteristics and high input characteristics (durability) can be provided.

The amount of fluoride ions (F⁻) can be measured by an ordinary ion chromatography (IC) technique. The amount (μg/mg) of fluoride ions per unit mass of the positive electrode active material layer can be determined by dividing the mass (μg) of the fluoride ions by the mass (mg) of the positive electrode active material layer used in measurement.

In addition, peak intensity of the Li—K absorption edge (and typically, the maximum peak intensity over the range of a prescribed energy region (eV)) can be determined by X-ray absorption fine structure (XAFS) analysis using the beam line (BL) of a synchrotron radiation facility. Detailed descriptions of specific measuring apparatuses and measurement conditions are provided in the examples to be subsequently described.

In addition, according to the present invention, a method for producing a nonaqueous electrolyte secondary battery is provided. This production method includes: (1) preparing a positive electrode provided with a positive electrode active material layer, a negative electrode provided with a negative electrode active material layer and an electrolyte containing a lithium salt having fluorine as a constituent thereof (F-containing lithium salt), and (2) constructing a nonaqueous electrolyte secondary battery using the positive electrode, the negative electrode and the nonaqueous electrolyte, and forming films containing lithium ions and fluoride ions on the positive electrode and the negative electrode, respectively. A positive electrode having a moisture concentration of the positive electrode active material layer based on the Karl Fischer method (heating temperature: 300° C.) of 2100 ppm to 3400 ppm is used for the positive electrode, while a negative electrode having a moisture concentration of the negative electrode active material layer based on the Karl Fischer method (heating temperature: 120° C.) of 440 ppm or less is used for the negative electrode.

According to this method, a nonaqueous electrolyte secondary battery can be stably produced that demonstrates superior balance between release and acceptance of the charge carrier (Li) as previously described by a comparatively simple procedure consisting of using electrodes for which moisture concentration has been adjusted when constructing a battery.

Furthermore, examples of the related background art include Patent Literature Nos. 2 to 5.

In the present description, a value “based on the Karl Fischer method (heating temperature: 300° C.)” refers to a value obtained by measuring the amount of water that vaporizes when the positive electrode has been heated for 30 minutes at 300° C. according to a moisture vaporization-coulometric titration method using an ordinary Karl Fischer moisture meter. In general, the positive electrode active material contains two types of water consisting of water that adsorbs to the surface and crystallization water contained in crystals. By heating the positive electrode at 300° C., not only the adsorbed water, but also the crystallization water can be vaporized. Consequently, the total amount of water of the positive electrode can be determined.

In addition, in the present description, a value “based on the Karl Fischer method (heating temperature: 120° C.)” refers to a value determined by measuring the amount of water that vaporizes when the negative electrode has been heated for 15 minutes at 120° C. according to a moisture vaporization-coulometric titration method using an ordinary Karl Fischer moisture meter.

In addition, in the present description, “moisture concentration (ppm)” refers to a mass percentage, namely ppm (mass/mass) obtained by dividing the amount of water contained in an active material layer (mass) by the mass of the active material (mass).

In one preferable aspect, formation of a film on the positive electrode is carried out such that the ratio (C1/C2) of a first peak intensity C1 of 58 to 62 eV to a second peak intensity C2 of 68 to 72 eV, based on X-ray absorption fine structure (XAFS) analysis of the Li—K absorption edge of the film, is 2.0 or more, and the fluoride ions are contained at 1.99 μg/mg to 3.13 μg/mg per unit mass of the positive electrode active material layer.

In another preferable aspect, formation of a film on the negative electrode is carried out such that the ratio (A1/A2) of a first peak intensity A1 of 58 to 62 eV based on X-ray absorption fine structure (XAFS) analysis of the Li—K absorption edge of the film to a second peak intensity A2 of 68 to 72 eV is 2.0 or less.

### BRIEF DESCRIPTION OF DRAWINGS

FIG. 1 is a longitudinal cross-sectional view schematically representing a nonaqueous electrolyte secondary battery according to one embodiment.

FIG. 2 is a graph representing the relationship between moisture concentration and XAFS peak intensity ratio C1/C2 of a positive electrode active material layer.

FIG. 3 is a graph representing the relationship between moisture concentration and XAFS peak intensity ratio A1/A2 of a negative electrode active material layer.

FIG. 4 is a graph representing the relationship between moisture concentration of a positive electrode active material layer and the content of fluoride ions in a film.

FIG. 5A is a graph representing the relationship between the content of fluoride ions in a positive electrode film and battery characteristics.

FIG. 5B is a graph representing the relationship between XAFS peak intensity ratio C1/C2 of a positive electrode and battery characteristics.

FIG. 5C is a graph representing the relationship between XAFS peak intensity ratio A1/A2 of a negative electrode and battery characteristics.

### DESCRIPTION OF EMBODIMENTS

The following provides an explanation of preferred embodiments of the present invention. Furthermore, matters other than those specifically mentioned in the present description that are required to carry out the present invention (such as battery constituents or ordinary production processes not characterizing the present invention) can be understood by a person with ordinary skill in the art to be design matters based on the related art in the relevant field. The present invention can be carried out based on the contents disclosed in the present description and common general technical knowledge in the relevant field.

<<Nonaqueous Electrolyte Secondary Battery>>

The nonaqueous electrolyte secondary battery disclosed herein (and typically, a lithium ion secondary battery) is provided with a positive electrode provided with a positive electrode active material layer, a negative electrode provided with a negative electrode active material layer, and a nonaqueous electrolyte. The positive electrode and the negative electrode are characterized in that they are respectively provided with a film having prescribed properties and in a prescribed amount. Thus, there are no particular limitations on other constituents and those constituents can be suitably determined corresponding to various objectives and applications.

The following provides a sequential explanation of each constituent.

<Positive Electrode>

The positive electrode of the nonaqueous electrolyte secondary battery disclosed herein is typically provided with a positive electrode current collector and a positive electrode active material layer formed on the positive electrode current collector. The positive electrode current collector is preferably an electrically conductive member made of a metal having favorable electrical conductivity (such as aluminum or nickel). The positive electrode active material layer at least contains a positive electrode active material.

One type or two or more types of various types of materials known to be able to be used as positive electrode active materials of nonaqueous electrolyte secondary batteries can be used for the positive electrode active material. Preferable examples thereof include stratified or spinel-based lithium compound metal oxides such as LiNiO₂, LiCoO₂, LiMn₂O₄, LiFeO₂, LiNi_{0.5}Mn_{1.5}O₄, LiCrMnO₄ or LiFePO₄. Among these, lithium-nickel-cobalt-manganese compound oxides having a stratified structure (and typically, a stratified rock salt structure) represented by the following general formula (I): Li_{1+δ}(NiₐCo_{b}Mn_{c}M_{d})O₂ (wherein, M may or may not be contained and represents one type of two or more types selected from the group consisting of transition metals, typical metals, boron (B), silicon (Si) and fluorine (F), δ represents a value defined by 0≦δ≦0.2 so as to satisfy charge neutralized conditions, a, b, c and d satisfy the relationships of a>0, b>0, c>0, and a+b+c+d≅1) are preferable from the viewpoints of improved maintenance of thermal stability and high energy density.

There are no particular limitations on a, b and c in the general formula (I) provided they satisfy the relationships of a>0, b>0 and c>0 (namely, all the elements of Ni, Co and Mn are contained) and a+b+c+d≅1. For example, any of the values of a, b and c may be the largest. In other words, a first element among Ni, Co and Mn (element contained in the largest amount based on the number of atoms) may be any of Ni, Co and Mn. In addition, a may be such that, for example, 0.1<a<0.9. b may be such that 0.1<b<0.4. c may be such that 0<c<0.5.

In a preferable aspect, a>b and a>c (or in other words, the first element is Ni).

In another preferable aspect, a, b and c (namely, the amounts of Ni, Co and Mn) are roughly equal. A specific example thereof is LiNi_{1/3}Co_{1/3}Mn_{1/3}O₂ in which a=b=c and d=0.

In addition, the general formula (I) may contain (namely, d<0) or may not contain (namely, d=0) as constituents one or more other types of element M other than Li, Ni, Co and Mn. This element M can typically be one type or two or more types selected from transition metal elements or typical metal elements and the like other than Ni, Co and Mn. Specific examples thereof include sodium (Na), magnesium (Mg), calcium (Ca), zirconium (Zr), chromium (Cr), tungsten (W), iron (Fe), zinc (Zn), boron (B), aluminum (Al) and tin (Sn). Furthermore, although there are no particular limitations on the amount of metal M (value of d in the general formula), it may be, for example, such that 0≦d≦0.02.

Such compound oxides are able to contain an oxyhydroxide (such as NiOOH, CoOOH or FeOOH) of a constituent metal element (such as Ni, Co or Mn) in a portion of the crystals thereof. This oxyhydroxide is able to decompose at a temperature of roughly 200 to 300° C. to form water. For example, nickel oxyhydroxide is able to form water in the vicinity of 220 to 230° C. according to the following reaction: 4NiOOH→4NiO+2H₂O+O₂.

Although there are no particular limitations on the properties of the positive electrode active material, it is typically in the form of particles or powder. The average particle diameter of a particulate positive electrode active material can be 20 μm or less (and typically, 1 to 20 μm, and for example, 5 to 10 μm). The specific surface area of a particulate positive electrode active material is 0.1 m²/g or more (and typically, 0.5 m²/g or more), and 20 m²/g or less (and typically, 10 m²/g or less, and for example, 5 m²/g or less). A positive electrode active material that satisfies one or two of the properties is able to secure a broad reaction field for the charge carrier. Consequently, even in the case of forming a film on a surface as in the technology disclosed herein, superior battery characteristics (such as high output characteristics) can be realized at a high level.

Furthermore, in the present description, “average particle diameter” refers to a particle diameter equivalent to a cumulative frequency of 50% by volume from the side of fine particles having a small particle diameter in a volume-based particle size distribution based on an ordinary laser diffraction-light scattering method (also referred to as D₅₀ or median diameter). In addition, in the present description, “specific surface area” refers to surface area measured according to the BET method (such as the BET 1-point method) using nitrogen gas (BET specific surface area).

The positive electrode disclosed herein (and typically, a positive electrode active material layer) is provided with a film containing lithium ions and fluoride ions on the surface thereof. This film is such that the ratio (C1/C2) of maximum peak intensity in the vicinity of 60 eV (first peak intensity) C1 to maximum peak intensity in the vicinity of 70 eV (second peak intensity) C2, based on X-ray absorption fine structure (XAFS) analysis of the Li—K absorption edge thereof, is 2.0 or more.

In XAFS analyses, the ratio (I/I₀) of an X-ray intensity (I) after X-raying a measurement target to the X-ray intensity (I₀) before irradiating a measurement target is measured and analyzed to obtain information such as the local structure of an atom of interest (such as the valence of the atom, adjacent atomic species or bonding properties).

For example, the Li—K edge of the film (lithium ions) has a first peak in an energy region in the vicinity of 60 eV (and typically, 58 to 62 eV), and has a second peak in an energy region in the vicinity of 70 eV (and typically, 68 to 72 eV). The first peak is a peak derived from strong ion crystallinity and ionic bonding of coordinating atoms. According to a study conducted by the inventor of the present invention, in the case a large amount of moisture is contained during battery construction (such as in an electrode active material layer that composes the battery), ion crystallinity of the film increases and intensity of the first peak tends to increase.

In the technology disclosed herein, the intensity of the first peak of the Li—K edge contained in the positive electrode film is made to be two times or more the intensity of the second peak (and typically, 2.0 to 2.5 times more, and for example, 2.2 to 2.3 times more). As a result, release of charge carrier in the positive electrode can be suitably suppressed, thereby making it possible to realize high durability (Li precipitation resistance). Furthermore, the positive electrode provided with a film having such properties can be fabricated by, for example, containing water at a prescribed concentration in a positive electrode active material layer as will be subsequently described.

In addition, fluoride ions are contained in the film at 1.99 μg to 3.13 μg per unit mass (1 mg) of the positive electrode active material layer. If the amount of fluoride ions is considerably greater than 3.13 μg/mg, resistance attributable to the film increases and output characteristics may decrease. In addition, if the amount of fluoride ions is considerably less than 1.99 μg/mg, release of the charge carrier (Li) becomes excessively large, acceptance of the charge carrier (Li) at the negative electrode is unable to keep up, and dendritic metal (and typically, Li dendrite) may precipitate. As a result of containing fluoride ions in the film of the positive electrode in the proportion, release of the charge carrier (Li) can be suitably suppressed (highly controlled). As a result, both output characteristics and durability can be realized at a high level.

In addition to the positive electrode active material, the positive electrode active material layer can contain as necessary one type or two or more types of materials able to be used as constituents of a positive electrode active material layer in an ordinary nonaqueous electrolyte secondary battery. Examples of such materials include an electrically conductive material and a binder. A carbon material such as various types of carbon black (such as acetylene black or Ketjen black), activated charcoal, graphite or carbon fiber can be preferably used for the electrically conductive material. In addition, vinyl halide resins such as polyvinylidene fluoride (PVdF) or polyalkylene oxides such as polyethylene oxide (PEO) can be preferably used for the binder. In addition, various types of additives (such as inorganic compounds for generating a gas during overcharging, dispersants or thickeners) can also be further contained provided they do not significantly impair the effects of the present invention.

The proportion of the positive electrode active material in the entire positive electrode active material layer is suitably made to be about 50% by mass or more (and typically, 60 to 95% by mass) from the viewpoint of realizing high energy density, and is normally about 80 to 95% by mass. In the case of using an electrically conductive material, the proportion of the electrically conductive material in the entire positive electrode active material layer can be made to be, for example, about 1 to 20% by mass from the viewpoint of realizing both output characteristics and energy density at a high level, and is normally about 2 to 10% by mass. In the case of using a binder, the proportion of binder in the entire positive electrode active material layer is, for example, about 0.5 to 10% by mass from the viewpoint of securing mechanical strength (shape retention), and is normally about 1 to 5% by mass.

The mass of the positive electrode active material layer provided per unit area of the positive electrode current collector (mass per unit area) is 3 mg/cm² or more (and for example, 5 mg/cm² or more and typically 7 mg/cm² or more) per side of the positive electrode current collector from the viewpoint of realizing high energy density. The mass per unit area of the positive electrode active material layer is 100 mg/cm² or less (and for example, 70 mg/cm² or less and typically 50 mg/cm² or less) per side of the positive electrode current collector from the viewpoint of realizing superior output characteristics. In addition, the average thickness per side of the positive electrode active material layer is, for example, 20 μm or more (and typically, 40 μm or more), and 100 μm or less (and typically, 80 μm or less). In addition, the density of the positive electrode active material layer is, for example, 1.0 g/cm³ or more (and typically, 2.0 g/cm³ or more) and 4.5 g/cm³ or less (for example, 4.0 g/cm³ or less). As a result of satisfying one or two or more of the properties, output characteristics and durability can be realized at a higher level during normal use.

<Negative Electrode>

The negative electrode of the nonaqueous electrolyte secondary battery disclosed herein is typically provided with a negative electrode current collector and a negative electrode active material layer formed on the negative electrode current collector. The negative electrode current collector is preferably an electrically conductive member made of a metal having favorable electrical conductivity (such as copper or nickel). The negative electrode active material layer at least contains a negative electrode active material.

One type or two or more types of various types of materials known to be able to be used as negative electrode active materials of nonaqueous electrolyte secondary batteries can be used for the negative electrode active material. Preferable examples thereof include graphite, non-graphitizable carbon (hard carbon), graphitizable carbon (soft carbon) and that having a structure that is a combination thereof. Among these, a graphite-based carbon material is preferable from the viewpoint of energy density.

Although there are no particular limitations on the properties of the negative electrode active material, it is typically in the form of particles or powder. The average particle diameter of a particulate negative electrode active material can be 50 μm or less (and typically, 30 μm or less, and for example, 10 μm to 25 μm). In addition, the specific surface area is 1 m²/g or more (and typically, 2 m²/g or more), and 10 m²/g or less (and typically, 5 m²/g or less). A negative electrode active material that satisfies one or two of the properties is able to secure a broad reaction field for the charge carrier. Consequently, even in the case of forming a film on a surface as in the technology disclosed herein, superior battery characteristics (such as high output characteristics) can be realized at a high level.

The negative electrode disclosed herein (and typically, a negative electrode active material layer) is provided with a film containing lithium ions and fluoride ions on the surface thereof. This film is such that the ratio (A1/A2) of maximum peak intensity in the vicinity of 60 eV (first peak intensity) A1 to maximum peak intensity in the vicinity of 70 eV (second peak intensity) A2, based on X-ray absorption fine structure (XAFS) analysis of the Li—K absorption edge thereof, is 2.0 or less. If the peak intensity ratio of the negative electrode exceeds 2.0 in the manner of the positive electrode, acceptability of the charge carrier (Li) becomes poor. As a result, Li precipitation resistance may decrease. As a result of making the first peak intensity to be two times or less the second peak intensity (and typically, 1.0 times to 1.5 times, and for example, 1.2 times to 1.3 times), resistance of the negative electrode can be reduced at a high level and acceptability of the charge carrier (Li) can be suitably secured. As a result, high durability (Li precipitation resistance) can be realized. Furthermore, the negative electrode provided with a film having such properties can be fabricated by, for example, controlling moisture content of the negative electrode active material by heating and drying as will be subsequently described.

In addition to the negative electrode active material, the negative electrode active material layer can contain as necessary one type or two or more types of materials able to be used as constituents of a negative electrode active material layer in an ordinary nonaqueous electrolyte secondary battery. Examples of such materials include a binder and various types of additives. Polymer materials such as styrene-butadiene rubber (SBR), polyvinylidene fluoride (PVdF) or polytetrafluoroethylene (PTFE) can be preferably used for the binder. In addition, various types of additives can be suitably used, such as thickeners, dispersants or electrically conductive materials, and examples of thickeners that can be used preferably include carboxymethyl cellulose (CMC) and methyl cellulose (MC).

The proportion of the negative electrode active material in the entire negative electrode active material layer is suitably made to be about 50% by mass or more from the viewpoint of realizing high energy density, and is normally about 90 to 99% by mass (and for example, 95 to 99% by mass). In the case of using a binder, the proportion of binder in the entire negative electrode active material layer can be made to be, for example, about 1 to 10% by mass from the viewpoint of securing mechanical strength (shape retention), and is normally about 1 to 5% by mass. In the case of using a thickener, the proportion of thickener in the entire negative electrode active material layer can be made to be, for example, about 1 to 10% by mass, and is normally about 1 to 5% by mass.

The mass of the negative electrode active material layer provided per unit area of the negative electrode current collector (mass per unit area) is 5 mg/cm² or more (and typically, 7 mg/cm² or more) and 20 mg/cm² or less (and typically, 15 mg/cm² or less) per side of the negative electrode current collector from the viewpoint of realizing high energy density and output density. The thickness per side of the negative electrode active material layer is, for example, 40 μm or more (and typically, 50 μm or more), and 100 μm or less (and typically, 80 μm or less). In addition, the density of the negative electrode active material layer is, for example, 0.5 g/cm³ or more (and typically, 1.0 g/cm³ or more) and 2.0 g/cm³ or less (for example, 1.5 g/cm³ or less). As a result of satisfying one or two or more of the properties, output characteristics and durability can be realized at a higher level during normal use.

<Nonaqueous Electrolyte>

The nonaqueous electrolyte of the nonaqueous electrolyte secondary battery disclosed herein contains a lithium salt having fluorine as a constituent thereof (F-containing lithium salt). This nonaqueous electrolyte is typically a liquid at normal temperature (for example, 25° C.) and is preferably always a liquid over the temperature range at which it is used (for example, −30 to 60° C.). In a preferable aspect, a F-containing lithium salt is contained in a nonaqueous solvent.

One type or two or more types of nonaqueous solvents among those conventionally used in nonaqueous electrolyte secondary batteries can be used without limitation for the nonaqueous solvent. Typical examples thereof include aprotic solvents such as carbonates, esters, ethers, nitriles, sulfones or lactones. Specific examples thereof include ethylene carbonate (EC), propylene carbonate (PC), diethyl carbonate (DEC), dimethyl carbonate (DMC) and ethyl methyl carbonate (EMC).

Examples of lithium salts having fluorine as a constituent thereof include LiPF₆, LiBF₄, LiAsF₆, LiN(SO₂CF₃)₂, LiN(SO₂C₂F₅)₂, LiCF₃SO₃, LiC₄F₉SO₃ and LiC(SO₂CF₃)₃. One type of such lithium salts can be used alone or two or more types can be used in combination. Among these, LiPF₆ is preferable. In addition, the concentration of the F-containing lithium salt is about 0.8 to 1.5 mol/L from the viewpoints of improving maintenance of ionic conductivity and reducing charge carrier resistance.

<<Production Method of Nonaqueous Electrolyte Secondary Battery>>

The nonaqueous electrolyte secondary battery disclosed herein can be produced according to, for example, the method indicated below.

(S10) A positive electrode provided with a positive electrode active material layer having prescribed properties, a negative electrode provided with a negative electrode active material layer having prescribed properties, and a nonaqueous electrolyte containing a F-containing lithium salt are prepared.

(S20) A nonaqueous electrolyte secondary battery is constructed using the positive electrode, the negative electrode and the nonaqueous electrolyte, and a film containing lithium ions and fluoride ions is formed on the positive electrode and the negative electrode, respectively.

A positive electrode having a moisture concentration of the positive electrode active material layer based on the Karl Fischer method (heating temperature: 300° C.) of 2100 ppm to 3400 ppm (and for example, 2128 ppm to 3344 ppm) is used for the positive electrode.

Such the positive electrode can be fabricated, for example, in the manner indicated below. First, a positive electrode active material, an electrically conductive material and a binder are prepared as previously described. Next, these materials are weighed out and mixed in a suitable solvent (such as N-methyl-2-pyrrolidone (NMP)) to prepare a slurry-like composition. Next, the prepared slurry is coated onto the surface of a positive electrode current collector to form a positive electrode active material layer. This is then held for a fixed amount of time in an environment provided with moisture (and typically, in a constant-temperature, constant-humidity chamber such as an environment at humidity of 50 to 100% RH). This holding time is suitably adjusted so as to realize the desired moisture concentration corresponding to the physical properties of the positive electrode active material and the properties of the positive electrode active material layer. The positive electrode provided with moisture is then heated and dried a prescribed temperature (for example, 50 to 100° C.). As a result, a positive electrode can be obtained in which moisture concentration has been highly adjusted.

A negative electrode having a moisture concentration of the negative electrode active material layer based on the Karl Fischer method (heating temperature: 120° C.) of 440 ppm or less (and for example, 310 ppm to 440 ppm) is used for the negative electrode.

Such the negative electrode can be fabricated, for example, by first preparing a negative electrode active material, a binder and a thickener as previously described. Next, these materials are weighed out and mixed in a suitable solvent (such as ion exchange water) to prepare a slurry-like composition. Next, the prepared slurry is coated onto the surface of a negative electrode current collector to form a negative electrode active material layer. This is then heated and dried at a prescribed temperature (for example, 50 to 100° C.) to obtain a negative electrode in which moisture concentration has been reduced to 440 ppm or less. Alternatively, after temporarily heating and drying, the negative electrode may be held for a fixed amount of time in an environment provided with moisture in the same manner as the positive electrode.

A nonaqueous electrolyte secondary battery can then be constructed by housing the positive electrode, the negative electrode and the nonaqueous electrolyte containing a F-containing lithium salt in a battery case and sealing the opening thereof. A case made of a lightweight metal material such as aluminum is preferably used for the battery case.

A portion of the F-containing lithium salt used to construct the battery chemically reacts with a trace amount of water contained in the battery enabling the formation of hydrogen fluoride (HF) and lithium fluoride (LiF). In addition, the hydrogen fluoride further reacts with lithium on the surfaces of the positive electrode and the negative electrode, and can be adhered (bound) to the surface of the negative and positive electrode in the form of a film.

The battery disclosed herein can be stably produced with high productivity using a method as described above. The nonaqueous electrolyte secondary battery disclosed herein can be respectively provided with a film containing lithium ions and fluoride ions on the surfaces of a positive electrode and a negative electrode. In a preferable aspect, the film of the positive electrode is such that the ratio (C1/C2) of a first peak intensity C1 of 58 to 62 eV to a second peak intensity C2 of 68 to 72 eV, based on X-ray absorption fine structure (XAFS) analysis of the Li—K absorption edge, is 2.0 or more. In another preferable aspect, the film of the positive electrode contains the fluoride ions at 1.99 μg/mg to 3.13 μg/mg per unit mass of the positive electrode active material layer. In addition, in another preferable aspect, the film of the negative electrode is such that the ratio (A1/A2) of a first peak intensity A1 of 58 to 62 eV to a second peak intensity A2 of 68 to 72 eV, based on X-ray absorption fine structure (XAFS) analysis of the Li—K absorption edge, is 2.0 or less.

### One Embodiment

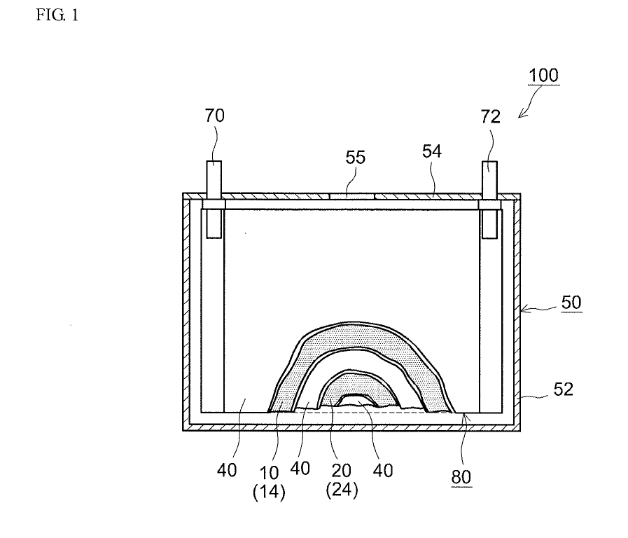

Although not intended as being particularly limiting, the nonaqueous electrolyte secondary battery (single cell) schematically indicated in FIG. 1 is used as an example to explain the approximate configuration of one embodiment of the present invention. In the following drawings, the same reference symbols are used to indicate those members or sites demonstrating the same action, and duplicate explanations thereof are omitted or simplified. The dimensional relationships in each drawing (such as length, width and thickness) do not necessarily reflect actual dimensional relationships.

FIG. 1 is a longitudinal cross-sectional view schematically showing the cross-sectional structure of a nonaqueous electrolyte secondary battery 100. The nonaqueous electrolyte secondary battery 100 has an electrode body (wound electrode body) 80, in which an elongated positive electrode sheet 10 and an elongated negative electrode sheet 20 are wound flat with an elongated separator sheet 40 interposed therebetween, and a nonaqueous electrolyte not shown, the electrode body 80 and the nonaqueous electrolyte being housed in a battery case 50 having a shape allowing the wound electrode body to be housed (flat box shape).

The battery case 50 is provided with a battery case body 52 in the shape of a flat rectangular parallelepiped (box) of which the upper end thereof is open, and a cover 54 that covers the opening. The upper surface of the battery case 50 (namely, the cover 54) is provided with a positive electrode terminal 70, which is electrically connected to the positive electrode of the wound electrode body 80, and a negative electrode terminal 72, which is electrically connected to the negative electrode of the wound electrode body 80. The cover 54 is also provided with a safety valve 55 for discharging gas generated within the battery case 50 outside the case 50 in the same manner as a battery case of a conventional nonaqueous electrolyte secondary battery.

The flat wound electrode body 80 is housed within the battery case 50 together with a nonaqueous electrolyte not shown. The wound electrode body 80 is provided with an elongated sheet-shaped positive electrode (positive electrode sheet) 10 and an elongated sheet-shaped negative electrode (negative electrode sheet) 20. The positive electrode sheet 10 is provided with an elongated positive electrode current collector and a positive electrode active material layer 14 formed along the lengthwise direction on at least one surface thereof (and typically on both sides). The negative electrode sheet 20 is provided with an elongated negative electrode current collector and a negative electrode active material layer 24 formed along the lengthwise direction on at least one surface thereof (and typically on both sides). In addition, two elongated sheet-shaped separators 40 are arranged between the positive electrode active material layer 14 and the negative electrode active material layer 24 in the form of insulating layers that prevent direct contact between the two. In addition to insulating the positive electrode and the negative electrode, the separators 40 have the functions of retaining and shutting down the nonaqueous electrolyte. Preferable examples thereof include porous resin sheets (films) formed of a resin such as polyethylene (PE), polypropylene (PP), polyester, cellulose or polyamide.

The positive electrode active material layer 14 formed on a surface of the positive electrode current collector and the negative electrode active material layer 24 formed on a surface of the negative electrode current collector overlap in the center of the wound electrode body 80 in the direction of width defined as the direction from one end to the other end in the winding axial direction of the wound electrode body 80, resulting in the formation of a densely laminated wound core. In addition, a positive electrode active material non-formed portion of the positive electrode sheet 10 and a negative electrode active material non-formed portion of the negative electrode sheet 20 are respectively protruding to the outside from the wound core on both ends in the winding axial direction of the wound electrode body 80. The positive electrode current collector is attached to the protruding portion on the positive electrode side, while the negative electrode current collector is attached to the protruding portion on the negative electrode side, and these are electrically connected to the positive electrode terminal 70 and the negative electrode terminal 72, respectively.

<<Applications of Nonaqueous Electrolyte Secondary Battery>>

Although the nonaqueous electrolyte secondary battery disclosed herein can be used in various applications, both high output density and high durability can be realized at a higher level in comparison with the related art due to the effect of preferably adjusting the balance between release and acceptance of the charge carrier (Li). Thus, the nonaqueous electrolyte secondary battery disclosed herein can be particularly preferably used in applications requiring high output density and high durability by taking advantage of this characteristic. Examples of such applications include motive power supplies for driving a motor installed in a vehicle such as a plug-in hybrid vehicle, hybrid vehicle or electric vehicle. Furthermore, this nonaqueous electrolyte secondary battery can typically be used in the form of a battery pack by connecting a plurality thereof in series and/or in parallel.

Although the following provides an explanation of several examples relating to the present invention, the present invention is not intended to be limited to that indicated in these specific examples.

A positive electrode active material in the form of LiNi_{1/3}Co_{1/3}Mn₁₃O₂ (NCM, particle diameter: 6 μm, specific surface area: 0.7 m²/g), an electrically conductive material in the form of acetylene black (AB), and a binder in the form of polyvinylidene fluoride (PVdF) were placed in a kneader so that the mass ratio of these materials was such that NCM:AB:PVdF was 91:6:3, followed by kneading while adjusting viscosity to a non-volatile (NV) solid fraction concentration of 50% by mass with N-methylpyrrolidone (NMP) to prepare a slurry for forming a positive electrode active material layer. This slurry was coated in the form of a band on elongated sheet-shaped aluminum foil having a thickness of 15 μm (positive electrode current collector) to a mass per unit area of 13.5 mg/cm² per side followed by drying (drying temperature: 80° C., 5 minutes) to fabricate a positive electrode sheet provided with a positive electrode active material layer on both sides of a positive electrode current collector. This was then roll-pressed to adjust the density of the positive electrode active material layer to about 2.6 g/cm³. Furthermore, the thickness of the positive electrode active material layer after roll-pressing was about 50 μm per side (total thickness of positive electrode: 115 μm).

Next, a negative electrode active material in the form of amorphous coated graphite (C, particle diameter: 25 μm, specific surface area: 2.5 m²/g), a binder in the form of styrene-butadiene rubber (SBR), and a thickener in the form of carboxymethyl cellulose (CMC) were placed in a kneader so that the mass ratio of these materials was such that C:SBR:CMC was 98:1:1, followed by kneading while adjusting viscosity to a non-volatile (NV) solid fraction concentration of 45% by mass with ion exchange water to prepare a slurry for forming a negative electrode active material layer. This slurry was coated in the form of a band on elongated sheet-shaped copper foil having a thickness of 10 μm (negative electrode current collector) to a mass per unit area of 7.3 mg/cm² per side followed by drying (drying temperature: 100° C., 5 minutes) to fabricate a negative electrode sheet provided with a negative electrode active material layer on both sides of a negative electrode current collector. This was then roll-pressed to adjust the density of the negative electrode active material layer to about 1.1 g/cm³. Furthermore, the thickness of the negative electrode active material layer after roll-pressing was about 60 μm per side (total thickness of positive electrode: 130 μm).

The positive electrode sheet and negative electrode sheet were stored for 24 to 336 hours in a constant temperature, constant humidity chamber adjusted to 25° C. and 50% RH followed by drying for 3 hours at 100° C. This was carried out to intentionally make the moisture concentrations of the positive and negative electrodes different.

A portion of the active material layer was scraped off from each of the positive electrode sheet and negative electrode sheet, and the moisture concentrations contained in the samples were measured according to an ordinary Karl Fischer method (moisture vaporization-coulometric titration method). Measurement conditions were as indicated below.

Measurement Conditions

(Positive electrode) heating conditions: 30 minutes at 300° C.

(Negative electrode) heating conditions: 15 minutes at 120° C.

The positive electrode sheet and negative electrode sheet provided with active material layers having the moisture concentrations shown in Table 1 were laminated and wound with two separator sheets (here, porous sheets having a three-layer structure consisting of polypropylene (PP) layers on both sides of a polyethylene (PE) layer (total thickness: 20 μm)) interposed therebetween, followed by forming into a flat shape to fabricate a wound electrode body. A positive electrode terminal was joined by welding to the edge of the positive electrode current collector of the wound electrode body (portion where the positive electrode active material layer is not coated), and a negative electrode terminal was joined by welding to the edge of the negative electrode current collector (portion where the negative electrode active material layer is not coated). The wound electrode body was housed in a square battery case followed by injection of a nonaqueous electrolyte (here, a nonaqueous electrolyte was used that was obtained by dissolving a supporting salt in the form of LiPF₆ at a concentration of 1 mol/L in a mixed solvent containing ethylene carbonate (EC), dimethyl carbonate (DMC) and ethyl methyl carbonate (EMC) at a volume ratio such that EC:DMC:EMC was 3:4:3) to obtain battery assemblies.

| | Positive Electrode Active Material Layer | | | Negative Electrode Active Material Layer | | Battery Characteristics | |
|---|---|---|---|---|---|---|---|
| | Moisture | Fluoride | XAFS | Moisture | XAFS | Discharge | Capacity |
| | concentration | ions in film | intensity | concentration | intensity ratio | resistance | retention |
| | 300° C. (ppm) | (μg/mg) | ratio C1/C2 | 120° C. (ppm) | A1/A2 | (mΩ) | rate (%) |
| Ex. 1 | 2128 | 1.99 | 2.2 | 310 | 1.2 | 69 | 89 |
| Ex. 2 | 3344 | 3.13 | 2.4 | 440 | 1.3 | 72 | 89 |
| Ex. 3 | 3801 | 3.60 | 2.5 | 400 | 1.3 | 80 | 91 |
| Ex. 4 | 1976 | 1.87 | 1.8 | 360 | 1.2 | 67 | 80 |
| Ex. 5 | 2512 | 2.30 | 2.2 | 660 | 2.4 | 70 | 82 |
| Ex. 6 | 3344 | 3.13 | 2.4 | 620 | 2.2 | 72 | 83 |

After charging the battery assemblies in a temperature environment of 25° C. and at a constant current of ⅓ C until the voltage between the terminals of the positive and negative electrodes reached 4.1 V, the battery assemblies were charged for 1.5 hours at a constant voltage (conditioning treatment). Next, The SOC of the batteries was adjusted to a state of 90% followed by holding for 20 hours in a temperature environment at 60° C. (ageing treatment). A plurality of nonaqueous electrolyte secondary batteries (Examples 1 to 6) was respectively fabricated in this manner.

(XAFS Measurement)

One of each of the batteries constructed in the manner described above was disassembled followed by measurement of XAFS. More specifically, the batteries were disassembled in a glove box controlled to a dew point of −80° C. or lower followed by removal of the positive electrode and the negative electrode. The batteries were transferred to a sample transport apparatus not exposed to the atmosphere within the glove box, and the samples (positive electrode and negative electrode) were placed in a measuring apparatus (BL) while kept from contacting air. The X-ray absorption spectrum of lithium (Li) atoms was measured for the samples under the conditions indicated below.

Measuring apparatus: BL-12, Synchrotron Radiation Facility,

Saga Prefecture, Kyushu, Japan

Measured absorption edge: Li—K absorption edge (50-75 eV)

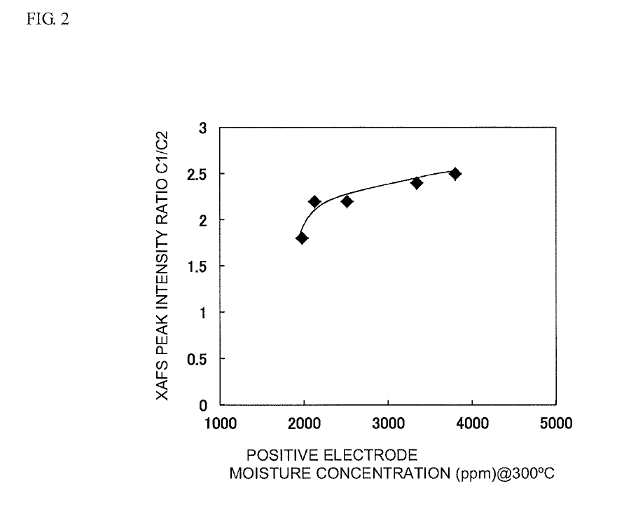

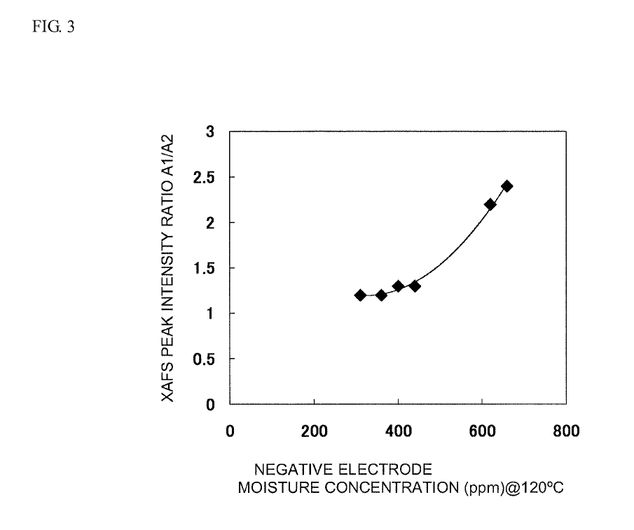

The first peak intensity in the vicinity of 60 eV and the second peak intensity in the vicinity of 70 eV were determined by subtracting the baseline value from the peak value of the resulting X-ray absorption spectrum. The intensity ratio (intensity of first peak/intensity of second peak) was then calculated. The results are shown in the applicable columns of Table 1. The relationship between moisture concentration of the positive electrode active material layer and XAFS peak intensity ratio C1/C2 is shown in FIG. 2, while the relationship between moisture concentration of the negative electrode active material layer and XAFS peak intensity ratio A1/A2 is shown in FIG. 3.

As is shown in Table 1 and FIGS. 2 and 3, a correlation was observed between moisture concentration and XAFS peak intensity ratio. Namely, in the case of a high moisture concentration in an active material layer, the first peak intensity in the vicinity of 60 eV in XAFS measurement of the film formed is strongly expressed, while in the case of a low moisture concentration, ion crystallinity tended to be relatively high in comparison with the film formed.

(Quantification of Fluoride Ions in Film of Positive Electrode)

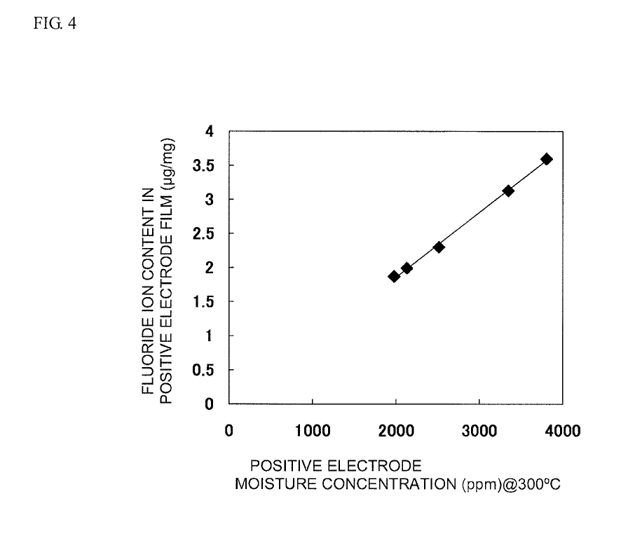

The film formed on the surface of the electrodes of the disassembled batteries was analyzed qualitatively and quantitatively using ion chromatography (IC). More specifically, the positive electrode (positive electrode active material layer) was first removed and washed by immersing in a suitable solvent (such as EMC) followed by cutting to a prescribed size. The sample was then immersed for about 30 minutes in a 50% aqueous acetonitrile solution to extract film components targeted for measurement into the solvent. This solution was then used for measurement by ion chromatography to quantify the target ions (F⁻ ions). The amount of fluoride ions per unit mass of the positive electrode active material layer was determined by dividing this quantified value (μg) by the mass (mg) of the positive electrode active material layer used in measurement. The results are shown in Table 1. In addition, the relationship between moisture concentration of the positive electrode active material layer and fluoride ion concentration in the film is shown in FIG. 4.

As shown in Table 1 and FIG. 4, a proportional relationship was observed between the moisture concentration of the positive electrode active material layer and the content of fluoride ions in the film. Namely, the content of fluoride ions tended to increase as the moisture concentration of the positive electrode active material layer increased.

(Measurement of Battery Characteristics: Discharge Resistance)

The batteries constructed in the manner described above were each adjusted to a state of 60% SOC and discharged for 10 seconds at a constant current of 15 C to measure the voltage drop amount. Resistance was then calculated by dividing the value of the measured voltage drop amount by the corresponding current value to obtain discharge resistance (mΩ). The results are shown in Table 1.

(Battery Characteristics: Li Precipitation Cycling Characteristics Test)

Next, the batteries were repeatedly charged and discharged for 4000 cycles of the following procedures (1) and (2) in a temperature environment at −30° C.:

(1) CC charging for 0.1 seconds at a rate of 40 C; and,

(2) CC charging for 10 seconds at a rate of 0.4 C.

Capacity retention rate (%) was calculated as the proportion of discharge capacity of the 4000th cycle to discharge capacity of the 1st cycle, and namely: capacity retention rate=(discharge capacity of 4000th cycle/discharge capacity of 1st cycle)×100(%). The results are shown in Table 1.

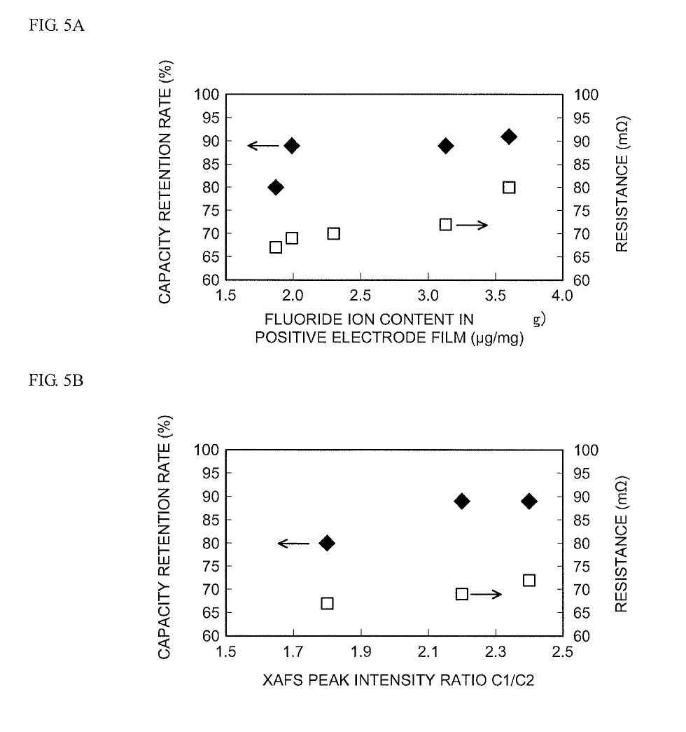

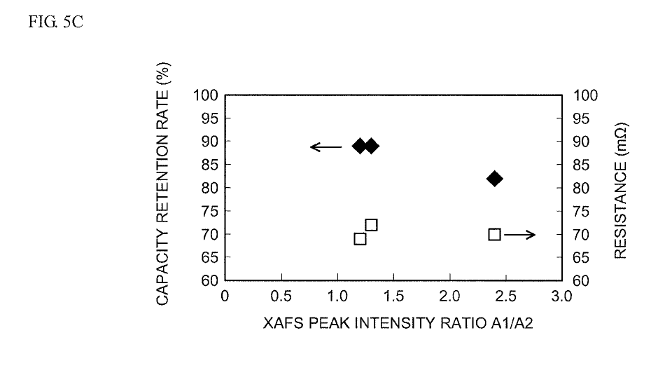

FIG. 5A represents the relationship between fluoride ion content in the film of the positive electrode and battery characteristics. In addition, FIG. 5B represents the relationship between XAFS peak intensity ratio C1/C2 of the positive electrode and battery characteristics, while FIG. 5C represents the relationship between XAFS peak intensity ratio A1/A2 of the negative electrode and battery characteristics.

As is clear from Table 1 and FIG. 5A, based on a comparison of Examples 1 to 3, it was determined that, by making the amount of fluoride ions per unit mass of the positive electrode active material layer to be 3.13 μg/mg or less (or in other words, by making the moisture concentration of the positive electrode active material layer to be 3344 ppm or less), discharge resistance at 25° C. can be held to a low level and high output characteristics can be realized.

In addition, as is clear from Table 1 and FIG. 5B, based on a comparison of Examples 1, 2 and 4, it was determined that, by making the amount of fluoride ions per unit mass of the positive electrode active material layer to be 1.99 μg/mg or more (or in other words, by making the moisture concentration of the positive electrode active material layer to be 2128 ppm or more), and making the peak intensity ratio C1/C2 of the positive electrode to be 2.0 or more (and typically, 2.0 to 2.5, and here, 2.2 to 2.4), Li release of the positive electrode can be suitably suppressed.

In addition, as is clear from Table 1 and FIG. 5C, based on a comparison of Examples 1, 2 and 5, it was determined that, by making the moisture concentration of the negative electrode active material to be 440 ppm or less (here, 310 to 440 ppm), and making the peak intensity ratio A1/A2 of the negative electrode to be 2.0 or less (and typically, 1.5 or less, and here, 1.2 to 1.3), Li acceptance at the negative electrode can be preferably secured.

In the technology disclosed herein, capacity retention rate following a Li precipitation cycling test is able to be made to be 85% or higher (and particularly, 89% or higher) based on these synergistic effects. In addition, in the technology disclosed herein, high durability can be realized even under conditions that facilitate the occurrence of problems such as lithium precipitation. In this manner, according to the present invention, a nonaqueous electrolyte secondary battery having both superior output characteristics and durability (resistance to Li precipitation) can be provided.

Although the above-mentioned description has provided a detailed explanation of specific examples of the present invention, these examples are merely intended to be exemplary and do not limit the scope of claim for patent. The technology described in the claims includes various alterations or modifications of the previously indicated specific examples.

### REFERENCE SIGNS LIST

10 Positive electrode sheet (positive electrode)
14 Positive electrode active material layer
20 Negative electrode sheet (negative electrode)
24 Negative electrode active material layer
40 Separator sheet (separator)
50 Battery case
52 Battery case body
54 Cover
55 Safety valve
70 Positive electrode terminal
72 Negative electrode terminal
80 Wound electrode body
100 Nonaqueous electrolyte secondary battery

1. A nonaqueous electrolyte secondary battery comprising:
a positive electrode provided with a positive electrode active material layer;
a negative electrode provided with a negative electrode active material layer; and
a nonaqueous electrolyte containing a lithium salt having fluorine as a constituent thereof, wherein
the positive electrode and the negative electrode are respectively provided with a film containing lithium ions and fluoride ions,
the film of the positive electrode is such that a ratio (C1/C2) of a first peak intensity C1 of 58 to 62 eV to a second peak intensity C2 of 68 to 72 eV, based on X-ray absorption fine structure (XAFS) analysis of the Li—K absorption edge, is 2.0 or more, and the fluoride ions are contained at 1.99 μg/mg to 3.13 μg/mg per unit mass of the positive electrode active material layer, and
the film of the negative electrode is such that a ratio (A1/A2) of a first peak intensity A1 of 58 to 62 eV to a second peak intensity A2 of 68 to 72 eV, based on X-ray absorption fine structure (XAFS) analysis of the Li—K absorption edge, is 2.0 or less.

2. The nonaqueous electrolyte secondary battery according to claim 1, wherein the ratio C1/C2 is 2.2 to 2.4.

3. The nonaqueous electrolyte secondary battery according to claim 1, wherein the ratio A1/A2 is 1.2 to 1.3.

4. A method for producing a nonaqueous electrolyte secondary battery, comprising:
preparing a positive electrode provided with a positive electrode active material layer, a negative electrode provided with a negative electrode active material layer and an electrolyte containing a lithium salt having fluorine as a constituent thereof; and
constructing a nonaqueous electrolyte secondary battery using the positive electrode, the negative electrode and the nonaqueous electrolyte, and forming films containing lithium ions and fluoride ions on the positive electrode and the negative electrode, respectively, wherein,
a positive electrode having a moisture concentration of the positive electrode active material layer based on the Karl Fischer method (heating temperature: 300° C.) of 2100 ppm to 3400 ppm is used for the positive electrode, and
a negative electrode having a moisture concentration of the negative electrode active material layer based on the Karl Fischer method (heating temperature: 120° C.) of 440 ppm or less is used for the negative electrode.

5. The production method according to claim 4, wherein formation of the film on the positive electrode is carried out such that a ratio (C1/C2) of a first peak intensity C1 of 58 to 62 eV to a second peak intensity C2 of 68 to 72 eV, based on X-ray absorption fine structure (XAFS) analysis of the Li—K absorption edge of the film, is 2.0 or more, and the fluoride ions are contained at 1.99 μg/mg to 3.13 μg/mg per unit mass of the positive electrode active material layer, and
formation of the film on the negative electrode is carried out such that a ratio (A1/A2) of a first peak intensity A1 of 58 to 62 eV to a second peak intensity A2 of 68 to 72 eV, based on X-ray absorption fine structure (XAFS) analysis of the Li—K absorption edge of the film, is 2.0 or less.
